(19) United States
(12) Patent Application Publication
(10) Pub. No.: US 2026/0149347 A1
(43) Pub. Date: May 28, 2026

(54) INDUCTION MOTOR INCLUDING ROTOR HAVING END SEGMENT PROTRUSIONS

(71) Applicant: Schaeffler Technologies AG & Co. KG, Herzogenaurach (DE)

(72) Inventors: Tuo LUO, Copley, OH (US); Eber Calebe PEREIRA DA SILVA, Jundiai (BR)

(21) Appl. No.: 18/958,036

(22) Filed: Nov. 25, 2024

(51) Int. Cl. H02K 17/16; H02K 15/00

(52) U.S. Cl. CPC H02K 17/168; H02K 15/023; H02K 2213/03

(57) ABSTRACT

An induction motor rotor includes a metal core; and an electrically conductive metal contiguous with the metal core. The electrically conductive metal includes rotor bars extending along the metal core and a first end segment and a second end segment formed onto opposite ends of the rotor bars. The first end segment and the second end segment each includes a base section extending a first axial distance from the metal core and a protrusion extending a second axial distance from the metal core. The second axial distance is greater than the first axial distance. Each of the protrusions is spaced radially inward from an outermost circumferential surface of the respective base section.

The present disclosure relates generally to induction motors and more specifically to rotors of induction motors used in motor vehicle drivetrains.

### BACKGROUND

Induction motors can have a squirrel cage design, with iron laminations inserted along a plurality of individual bars, which along with end segments, make up the squirrel cage. The rotor bars and end segments can be aluminum.

### SUMMARY

An induction motor rotor includes a metal core; and an electrically conductive metal contiguous with the metal core. The electrically conductive metal includes rotor bars extending along the metal core and a first end segment and a second end segment formed onto opposite ends of the rotor bars. The first end segment and the second end segment each includes a base section extending a first axial distance from the metal core and a protrusion extending a second axial distance from the metal core. The second axial distance is greater than the first axial distance. Each of the protrusions is spaced radially inward from an outermost circumferential surface of the respective base section.

In examples, a radial center of each of the first end section and the second end section is further away from a center axis of the induction motor rotor than a centroid of the respective first end section and the second end section.

In examples, along a circumferentially facing cross-section defined by a radial plane intersecting a center axis of the induction motor rotor, a radial center of each protrusion is closer to an innermost circumferential surface of the base section than to the outermost circumferential surface of the base section.

In examples, each base section and each protrusion is ring shaped, a centroid of each of the protrusions is radially inward from a centroid of the respective base section.

In examples, an innermost circumferential surface of at least one of the protrusions is a first distance from an innermost circumferential surface of the respective base section, an outermost circumferential surface of at least one of the protrusions is a second distance from the outermost circumferential surface of the respective base section, the second distance being greater than the first distance.

In examples, ratio of the second distance to the first distance is from 1.5:1 to 1.2:1.

In examples, each of the protrusions has an axial thickness that is less than an axial thickness of the respective base section.

In examples, the axial thickness of each of the protrusions is 40% to 70% of the axial thickness of the respective base section.

In examples, a radial thickness of each of the protrusions is 50% to 70% of a radial thickness of the respective base section.

In examples, each of the protrusions includes: a radially extending surface defining an axial peak of the protrusion; an outer circumferential surface that tapers radially away from the radially extending surface; and an inner circumferential surface that tapers radially away from the radially extending surface.

In examples, each of the base sections includes: an outer circumferential surface; a first radially extending surface extending radially inward from the outer circumferential surface to the outer circumferential surface of the protrusion; an inner circumferential surface; a second radially extending surface extending radially outward from the inner circumferential surface of the base section to the inner circumferential surface of the protrusion.

In examples, the outer circumferential surface of each of the protrusion forms an obtuse angel with the first radially extending surface of the respective base section, and wherein the inner circumferential surface of each of the protrusion forms an obtuse angel with the second radially extending surface of the respective base section.

In examples, a radial center of each of the first end section and the second end section is further away from a center axis of the induction motor rotor than a centroid of the respective first end section and the second end section, wherein the centroid of each of the first and second end sections is closer to a plane where the respective first or second end section joins the rotors bars than the axial peak of the protrusion.

In examples, an area of each protrusion, along a circumferentially facing cross-section defined by a radial plane intersecting a center axis of the induction motor rotor, is between 275 and 375 mm2 .

In examples, the electrically conductive metal includes at least 99% aluminum.

In examples, the induction motor rotor is a squirrel cage rotor.

In examples, at least one of the protrusions includes at least one axially extending balancing hole formed therein.

An induction motor is also provided that includes a stator; and a rotor rotatable with respect to the stator. The rotor includes a metal core, and an electrically conductive metal contiguous with the metal core. The electrically conductive metal includes rotor bars extending along the metal core and a first end segment and a second end segment formed onto opposite ends of the rotor bars. The first end segment and the second end segment each include a base section extending a first axial distance from the metal core and a protrusion extending a second axial distance from the metal core. The second axial distance is greater than the first axial distance. Each of the protrusions is spaced radially inward from an outermost circumferential surface of the respective base section.

A method of manufacturing an induction motor rotor including joining an electrically conductive metal to a metal core to form rotor bars interleaved between circumferentially spaced segments of the metal core and end segments formed onto opposite ends of the rotor bars. Each of the end segments protrudes axially past the metal core and includes a base section extending a first axial distance from the metal core and a protrusion extending a second axial distance from the metal core. The second axial distance is greater than the first axial distance. The protrusions are formed to cause a radial center of each of the first end section and the second end section to be further away from a center axis of the induction motor rotor than a centroid of the respective first end section and the second end section.

In examples, the method further includes machining balancing holes into the protrusion to balance the rotor.

### BRIEF SUMMARY OF THE DRAWINGS

The present disclosure is described below by reference to the following drawings, in which:

FIG. 1a shows a cross-sectional view of a stator and a rotor of an induction motor according to the present disclosure;

FIG. 1b shows a perspective view of an electrically conductive metal of the rotor shown in FIG. 1a;

FIG. 1c shows the rotor and a rotor shaft;

FIG. 2 shows a view of one of the end segments of the rotor shown in FIGS. 1a to 1c along a circumferentially facing cross-section defined by a radial plane intersecting a center axis of the induction motor rotor; and

FIG. 3 shows balancing holes formed in one of the end segments of the rotor shown in FIGS. 1a to 1c.

### DETAILED DESCRIPTION

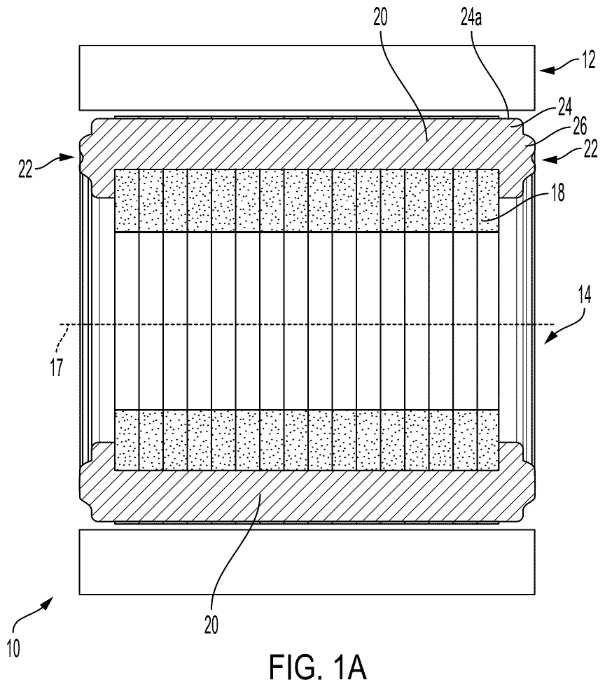

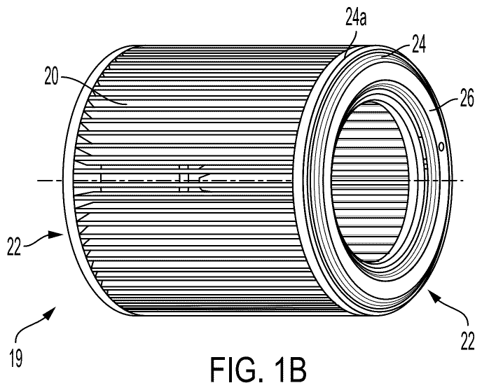

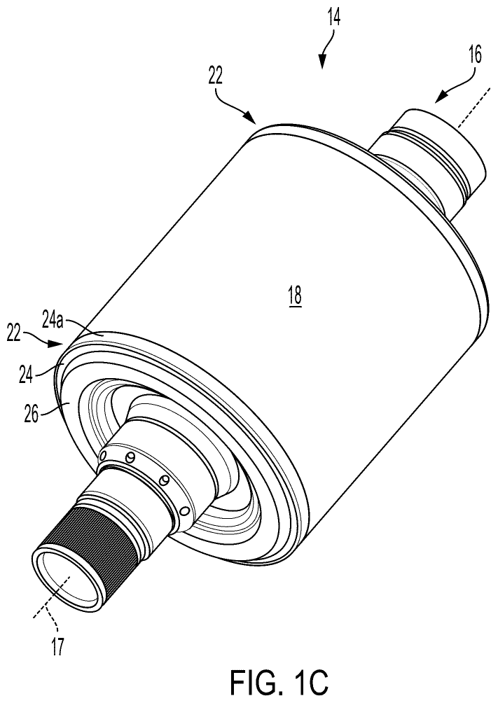

FIGS. 1a to 1c show components of an induction motor 10. FIG. 1a shows a cross-sectional view of a stator 12 and a rotor 14 of induction motor 10. As illustrated in FIG. 1c, rotor 14 is non-rotatably fixed to a rotor shaft 16, with rotor 14 and rotor shaft 16 being rotatable together within stator 12 about a center axis 17 in a known manner. Unless otherwise specified, the terms axial, radial, circumferential and derivatives thereof refer to center axis 17. As illustrated in FIG. 1b, the rotor 14 is a squirrel cage rotor and includes a metal core 18 and an electrically conductive metal 19 that includes rotor bars 20 and end segments 22. Rotor bars 20 extend along the metal core 18 and end segments 22 are formed onto opposite ends of the rotor bars 20.

Rotor bars 20 are electrically conductive and provide a path for the flow of current within rotor 14. Rotor bars 20 are shorted at the ends by end segments 22, forming a closed loop. When the motor 10 is energized, a magnetic field of the stator 12 induces an electric current in the rotor bars 20. Metal core 18 provides a path for the magnetic flux generated by windings of stator 12 by channeling the magnetic field produced by the stator 12 to the rotor bars 20. Electrically conductive metal 19 is contiguous with the electric metal core 18 and electrically conductive metal 19 can be joined with metal core 18 by casting to formed rotor bars 20 and end segments 22.

Each of the end segments 22 includes a base section 24 extending a first axial distance from the metal core 18 and a protrusion 26 extending a second axial distance from the metal core 18, with the second axial distance being greater than the first axial distance. Each of the protrusions 26 is spaced radially inward from an outermost circumferential surface 24a of the respective base section 24.

Protrusions 26, which have an annular shape, are provided for balancing rotor 14 during production and assembly of motor 10. In particular, protrusions 26 provide extra mass that can be machined to form balancing holes 30 that balance rotor 14. Protrusions 26 can also achieve lower end segment 22 power loss due to electric resistance in order to reduce the thermal loading into motor 10, in comparison to end segments 26 without protrusions. However, as electrically conductive metal 19 is formed of a material having a relatively low yield strength, end segments 22 with protrusions 26 can separate from rotor bars 20 during operation of rotor 14 at high RPM loading unless protrusions 26 are properly positioned with respect to base sections 24.

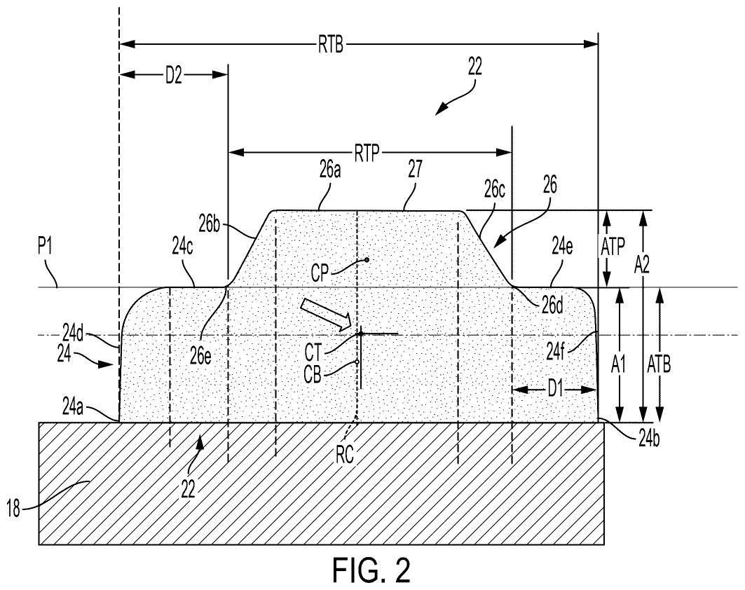

As illustrated in FIG. 2, along a circumferentially facing cross-section defined by a radial plane intersecting the center axis 17 of the induction motor rotor 10, protrusions 26 are configured so that a radial center RC of each of the end segments 22 is further away from center axis 17 than a centroid CT of the respective end segment 22. Protrusions 26 are configured so that the centroid CT of the circumferentially facing cross-section is as close as possible to center axis 17 while left enough mass at larger radius for balancing hole and keep the cross section of the end segment 22 large enough to reduce equivalent electric resistance to achieve less power loss. The centroid CT of each protrusion 26, viewed as a circumferentially facing cross-section as shown in FIG. 2, is closer to an innermost circumferential surface 24b of the base section 24 than to the outermost circumferential surface 24a of the base section 24. The radial center RC of each of the end segments 22 is halfway between the innermost circumferential surface 24b of the base section 24 and the outermost circumferential surface 24a of the base section 24.

Each base section 24 and each protrusion 26 is ring shaped, and a centroid CP of each of the protrusions 26 is radially inward from a centroid CB of the respective base section 24.

Each of the protrusions 26 includes a radially extending surface 26a defining an axial peak 27 of the protrusion 26, an outer circumferential surface 26b that tapers radially away from the radially extending surface 26a, and an inner circumferential surface 26c that tapers radially away from the radially extending surface 26a. The centroid CT is closer to a respective plane P where the respective end section 22 joins the rotors bars 20, than the axial peak of the protrusion 26.

Each of the base sections 24 includes a first radially extending surface 24c extending radially inward from an outer circumferential surface 24d to the outer circumferential surface 26b of the protrusion 26. Each of the base sections 24 also includes a second radially extending surface 24e extending radially outward from the inner circumferential surface 24b of the base section 24 to the inner circumferential surface 26f of the protrusion 26.

Base section 24 extends a first axial distance A1 from the metal core 18 and the protrusion 26 extends a second axial distance A2 from the metal core 18. In particular, an axial edge of base section 24 defined by radially extending surfaces 24c, 24e defines a radially extending plane P1, and protrusion 26 extends axially past radially extending plane P1.

An innermost circumferential surface 26d of surface 26b of each of the protrusions 26 is a first distance D1 from the innermost circumferential surface 24b of the respective base section 24, and an outermost circumferential surface 26e of surface 26 of at least one of the protrusions 26 is a second distance D2 from the outermost circumferential surface 24a of the respective base section 24. The second distance D2 is greater than the first distance D1. A ratio of the second distance to the first distance can be from 1.5:1 to 1.2:1.

Each of the protrusions 26 has an axial thickness ATP that is less than an axial thickness ATB of the respective base section 24. The axial thickness ATP of each of the protrusions 26 is 40% to 70% of the axial thickness ATB of the respective base section 24. A radial thickness RTP of each of the protrusions is 50% to 70% of a radial thickness RTB of the respective base section.

The outer circumferential surface 26b of each of the protrusion 26 forms an obtuse angel with the first radially extending surface 24c of the respective base section 24, and the inner circumferential surface 26c of each of the protrusion 26 forms an obtuse angel with the second radially extending surface of the respective base section.

In order to have sufficient electrical conductivity and to provide enough material to form protrusion 26, an area of each protrusion 26, viewed as a circumferentially facing cross-section as shown in FIG. 2, is between 275 and 375 mm2.

In examples, the electrically conductive metal 19 can be aluminum. In particular, the electrically conductive metal 19 can include at least 99% of aluminum. An example aluminum alloy is Al alloy 1XXX. Metal core 18 can for example be formed of steel laminations.

The mechanical strength of electrically conductive metal 19 is limited, ductile but softer than the metal core 18. For example, the electrically conductive metal 19 including at least 99% of aluminum has yield strength of 30-50MPa and UTS below 100MPa with plastic fracture limit of 30%-60%. The mechanical strength of end segments 22 including protrusions 26 is usually the weakest point under high RPM loading, and the configuration of protrusions 26 provides sufficient mechanical strength.

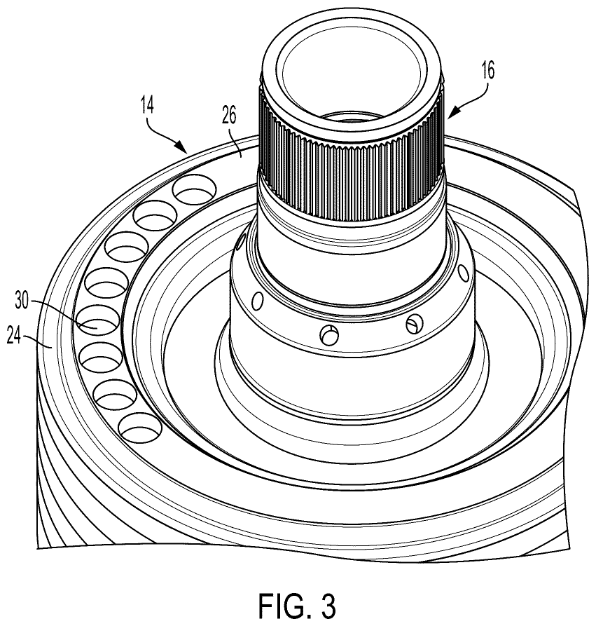

FIG. 3 shows rotor 14 provided on rotor shaft 16 with a plurality of balancing holes 30 being formed axially into one of the protrusions 26. Eight balancing holes 30 are shown in FIG. 3.

The balancing holes 30 are machined after a rotational assembly including shaft 16 and rotor 14 is assembled. An imbalance of the rotational assembly is measured, and balancing holes 30 are drilled into protrusions 26 by machining the material off from the second half of the protrusion 26. Based on the imbalance measure, zero to eight balancing holes 30 can be machined into each axial end concentrated into a quarter section with a spacing of ˜2.5mm between the edge of holes 30. Balancing holes 30 can be provided on one or both axial ends. For example, if the only imbalance mass is on one axial end, then one or more holes 30 can be drilled on that end at a location that mitigate the effect of the imbalance. Balancing holes 30 are formed axially into the axially facing radially extending surface 26a of protrusion 26.

A method of forming the rotor 14 can include measuring a mass imbalance of the rotor 14, and machining balancing holes 30 into the protrusion 26 to balance the rotor 14.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

### LIST OF REFERENCE NUMERALS

10 motor
12 stator
14 rotor
16 rotor shaft
17 center axis
18 metal core
19 electrically conductive metal
20 rotor bars
22 end segments
24 base section
24a outermost circumferential surface
24b innermost circumferential surface
24c first radially extending surface
24d outer circumferential surface
24e second radially extending surface
26 protrusions
26a radially extending surface
26b outer circumferential surface
26c inner circumferential surface
26d innermost circumferential surface
26e outermost circumferential surface
26f inner circumferential surface
27 axial peak
30 balancing holes

What is claimed is:

1. An induction motor rotor comprising:
a metal core; and
an electrically conductive metal contiguous with the metal core, the electrically conductive metal including rotor bars extending along the metal core and a first end segment and a second end segment formed onto opposite ends of the rotor bars,
the first end segment and the second end segment each including a base section extending a first axial distance from the metal core and a protrusion extending a second axial distance from the metal core, the second axial distance being greater than the first axial distance,
each of the protrusions being spaced radially inward from an outermost circumferential surface of the respective base section.

2. The induction motor rotor as recited in claim 1 wherein, along a circumferentially facing cross-section defined by a radial plane intersecting a center axis of the induction motor rotor, a radial center of each of the first end section and the second end section is further away from a center axis of the induction motor rotor than a centroid of the respective first end section and the second end section.

3. The induction motor rotor as recited in claim 1 wherein, along a circumferentially facing cross-section defined by a radial plane intersecting a center axis of the induction motor rotor, a radial center of each protrusion is closer to an innermost circumferential surface of the base section than to the outermost circumferential surface of the base section.

4. The induction motor rotor as recited in claim 1 wherein each base section and each protrusion is ring shaped, a centroid of each of the protrusions is radially inward from a centroid of the respective base section.

5. The induction motor rotor as recited in claim 4 wherein an innermost circumferential surface of at least one of the protrusions is a first distance from an innermost circumferential surface of the respective base section,
an outermost circumferential surface of at least one of the protrusions is a second distance from the outermost circumferential surface of the respective base section,
the second distance being greater than the first distance.

6. The induction motor rotor as recited in claim 1 wherein ratio of the second distance to the first distance is from 1.5:1 to 1.2:1.

7. The induction motor rotor as recited in claim 1 wherein each of the protrusions has an axial thickness that is less than an axial thickness of the respective base section.

8. The induction motor rotor as recited in claim 7 wherein the axial thickness of each of the protrusions is 40% to 70% of the axial thickness of the respective base section.

9. The induction motor rotor as recited in claim 1 wherein a radial thickness of each of the protrusions is 50% to 70% of a radial thickness of the respective base section.

10. The induction motor rotor as recited in claim 1 wherein each of the protrusions includes:
a radially extending surface defining an axial peak of the protrusion;
an outer circumferential surface that tapers radially away from the radially extending surface; and
an inner circumferential surface that tapers radially away from the radially extending surface.

11. The induction motor rotor as recited in claim 10 wherein each of the base sections includes:
an outer circumferential surface;
a first radially extending surface extending radially inward from the outer circumferential surface to the outer circumferential surface of the protrusion;
an inner circumferential surface;
a second radially extending surface extending radially outward from the inner circumferential surface of the base section to the inner circumferential surface of the protrusion.

12. The induction motor rotor as recited in claim 11 wherein the outer circumferential surface of each of the protrusion forms an obtuse angel with the first radially extending surface of the respective base section, and
wherein the inner circumferential surface of each of the protrusion forms an obtuse angel with the second radially extending surface of the respective base section.

13. The induction motor rotor as recited in claim 10 wherein a radial center of each of the first end section and the second end section is further away from a center axis of the induction motor rotor than a centroid of the respective first end section and the second end section,
wherein the centroid of each of the first and second end sections is closer to a plane where the respective first or second end section joins the rotors bars than the axial peak of the protrusion.

14. The induction motor rotor as recited in claim 1 wherein an area of each protrusion, viewed as a circumferentially facing cross-section, is between 275 and 375 mm2 .

15. The induction motor rotor as recited in claim 1 wherein the electrically conductive metal includes at least 99% aluminum.

16. The induction motor rotor as recited in claim 1 wherein the induction motor rotor is a squirrel cage rotor.

17. The induction motor rotor as recited in claim 1 wherein at least one of the protrusions includes at least one axially extending balancing hole formed therein.

18. An induction motor comprising:
a stator; and
a rotor rotatable with respect to the stator, the rotor comprising:
a metal core; and
an electrically conductive metal contiguous with the metal core, the electrically conductive metal including rotor bars extending along the metal core and a first end segment and a second end segment formed onto opposite ends of the rotor bars,
the first end segment and the second end segment each including a base section extending a first axial distance from the metal core and a protrusion extending a second axial distance from the metal core, the second axial distance being greater than the first axial distance,
each of the protrusions being spaced radially inward from an outermost circumferential surface of the respective base section.

19. A method of manufacturing an induction motor rotor comprising:
joining an electrically conductive metal to a metal core to form rotor bars interleaved between circumferentially spaced segments of the metal core and end segments formed onto opposite ends of the rotor bars, each of the end segments protruding axially past the metal core and including a base section extending a first axial distance from the metal core and a protrusion extending a second axial distance from the metal core, the second axial distance being greater than the first axial distance,
the protrusions being formed to cause a radial center of each of the first end section and the second end section to be further away from a center axis of the induction motor rotor than a centroid of the respective first end section and the second end section.

20. The method as recited in claim 19 further comprising machining balancing holes into the protrusion to balance the rotor.
